(19) United States
(12) Patent Application Publication
(10) Pub. No.: US 2026/0220517 A1
(43) Pub. Date: Jul. 30, 2026

(54) EFFICIENT SELF-ATTENTION USING A LEARNED QUANTUM KERNEL

(71) Applicant: IonQ, Inc., College Park, MD (US)

(72) Inventor: Jonathan MEI, Union City, NJ (US)

(73) Assignee: IonQ, Inc., College Park, MD (US)

(21) Appl. No.: 19/364,579

(22) Filed: Oct. 21, 2025

Related U.S. Application Data
(60) Provisional application No. 63/717,136, filed on Nov. 6, 2024.

(51) Int. Cl. G06N 10/60

(52) U.S. Cl. CPC G06N 10/60

(57) ABSTRACT

A system inputs a training input value into the self-attention head of the transformer model, wherein the training input value is multiplied by three distinct weight matrices to produce a query (Q) vector, a key (K) vector, and a value (V) vector. The system trains a quantum kernel within the self-attention head, wherein quantum kernel is implemented as a parameterized quantum circuit (PQC) with adjustable parameters, and wherein training comprises: encoding the Q vector and the K vector for input into the PQC, generating an output kernel (A) vector; and updating the adjustable parameters of the PQC to reduce a difference between the A vector and a target A vector corresponding to the training input value. The system calculates an output head vector that is a matrix product between the A vector and the V vector. The system outputs, for display, the output head vector.

### CROSS-REFERENCE TO RELATED APPLICATIONS

This application claims the benefit of U.S. Provisional Application No. 63/717,136, filed Nov. 6, 2024, which is herein incorporated by reference.

### TECHNICAL FIELD

Aspects of the present disclosure relate generally to systems and methods for use in the implementation, operation, and/or use of quantum information processing (QIP) systems for training and executing self-attention transformers.

### BACKGROUND

Modern large language models (LLMs) are primarily built upon the transformer architecture, a framework that has advanced the field of natural language processing. A key feature of the transformer is its use of self-attention mechanisms, which allow the model to weigh the importance of different words in a sentence relative to each other. This capability enables the model to capture complex dependencies and contextual relationships within the text.

The standard transformer employs a specific type of self-attention known as the softmax dot-product attention. This involves calculating a weighted sum of the input features, where the weights are determined by the similarity between different elements of the input. The softmax function is used to normalize these weights, ensuring they sum to one and can be interpreted as probabilities.

However, there is significant room for improvement in training and executing transformers. Advancements such as faster computations are crucial for making transformers more accessible and practical for real-world applications, where speed and efficiency are often as important as accuracy.

### SUMMARY

Viewing the softmax dot-product operation through the lens of a kernel function opens up possibilities for optimization. By approximating the self-attention computation, it is possible to enhance the efficiency of transformers. These approximations can lead to faster computations with only a slight reduction in accuracy. Moreover, learning a dynamic kernel, as opposed to using a fixed softmax dot-product kernel, can further improve the model's performance by adapting to the specific characteristics of the data. More specifically, the present disclosure describes using quantum methods to not only compute but also learn the self-attention matrix kernel.

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of systems and methods for use in the implementation and/or operation of quantum information processing (QIP) systems, and more particularly, to implementation of efficient self-attention using a learned quantum kernel.

In some aspects, the techniques described herein relate to a method for executing a quantum kernel in a self-attention head of a transformer model, the method including: inputting a training input value into the self-attention head of the transformer model, wherein the training input value is multiplied by three distinct weight matrices to produce a query (Q) vector, a key (K) vector, and a value (V) vector, training a quantum kernel within the self-attention head, wherein quantum kernel is implemented as a parameterized quantum circuit (PQC) with adjustable parameters, and wherein training includes: encoding the Q vector and the K vector for input into the PQC; generating an output kernel (A) vector; and updating the adjustable parameters of the PQC to reduce a difference between the A vector and a target A vector corresponding to the training input value; calculating an output head vector that is a matrix product between the A vector and the V vector; and outputting, for display, the output head vector.

In some aspects, the techniques described herein relate to a quantum information processing (QIP) system for executing a quantum kernel in a self-attention head of a transformer model, the QIP system including: at least one memory; and at least one processor coupled with the at least one memory and configured, individually or in combination, to: input a training input value into the self-attention head of the transformer model, wherein the training input value is multiplied by three distinct weight matrices to produce a query (Q) vector, a key (K) vector, and a value (V) vector, train a quantum kernel within the self-attention head, wherein quantum kernel is implemented as a parameterized quantum circuit (PQC) with adjustable parameters, and wherein training includes: encoding the Q vector and the K vector for input into the PQC; generating an output kernel (A) vector; and updating the adjustable parameters of the PQC to reduce a difference between the A vector and a target A vector corresponding to the training input value; calculate an output head vector that is a matrix product between the A vector and the V vector; and output, for display, the output head vector.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an exemplary self-attention head utilizing a quantum kernel in a transformer.

FIG. 5 illustrates the utilization of a learned quantum kernel to train a self-attention head in a classical transformer.

FIG. 6 illustrates an exemplary method for executing a self-attention head with a quantum kernel in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators.

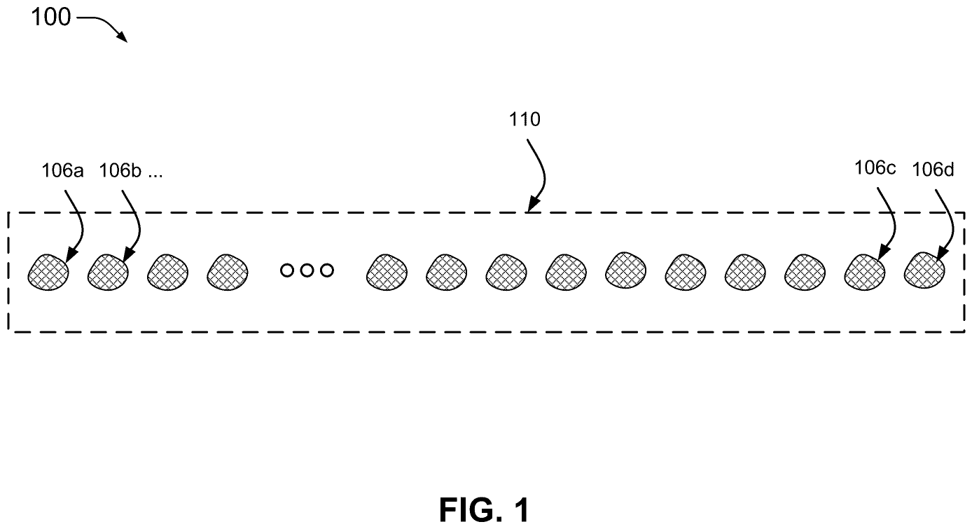

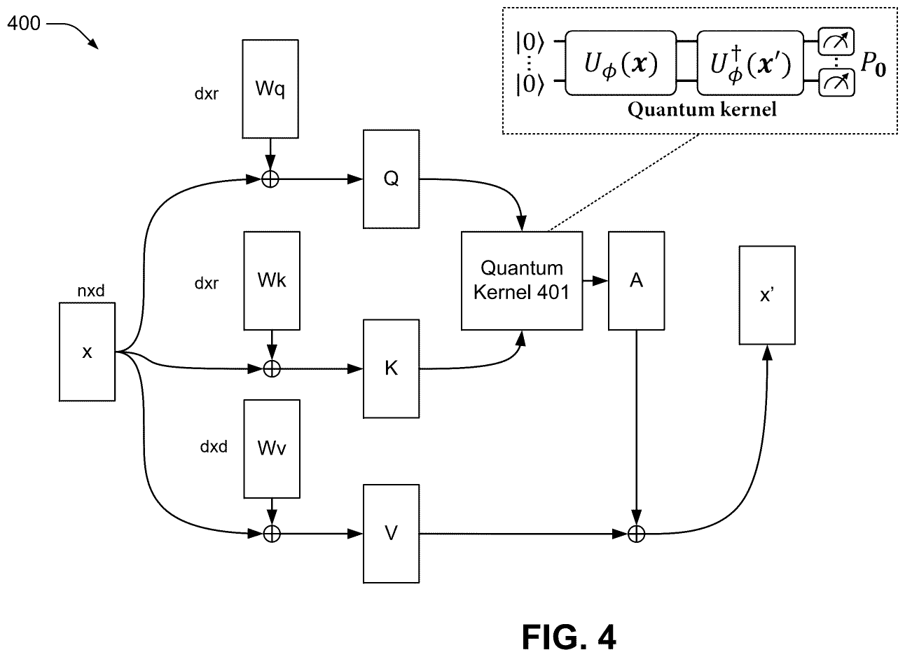

Solutions to the issues described above are explained in more detail in connection with FIGS. 4-6, with FIGS. 1-3 providing a background of QIP systems or quantum computers, and more specifically, of atomic-based QIP systems or quantum computers.

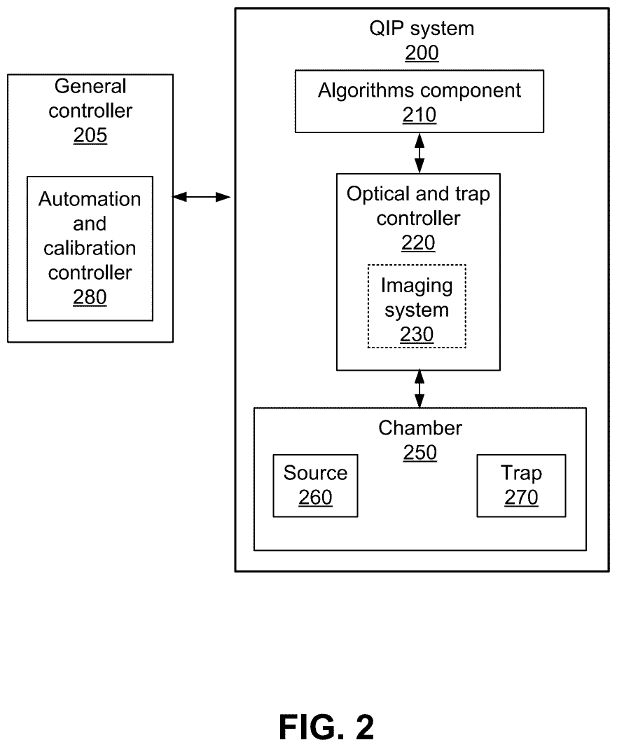

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may be a quantum processor that operates with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the QIP system 200 with the optical elements of a beam shaping structure as arranged therein.

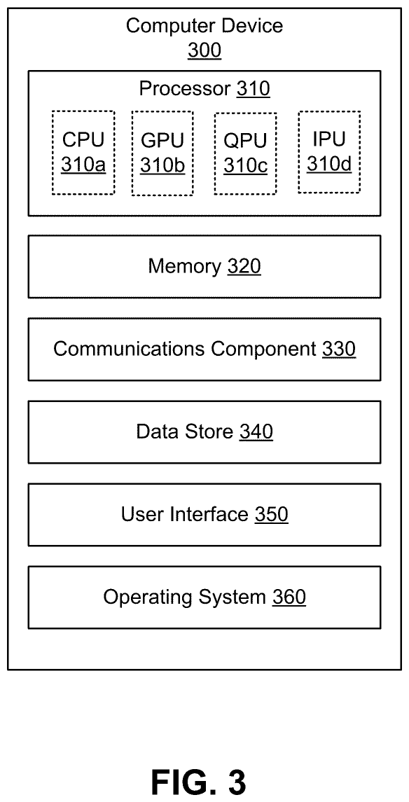

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

FIG. 4 illustrates an exemplary self-attention head 400 utilizing a quantum kernel 401 in a transformer. In reference to QIP system 200, self-attention head 400 may be trained and executed using algorithms component 210. In reference to FIG. 3, self-attention head 400 may be executed by processor 310. More specifically, within the infrastructure described in FIGS. 1-3, self-attention head 400 and quantum kernel 501 are realized as software and algorithmic modules that leverage, for example, QPU 310c for quantum feature mapping and kernel computation, while the algorithms component 210 orchestrates the training and optimization processes. The integration of these components enables the hybrid execution of quantum-enhanced transformer models, where quantum circuits process vectors, generate an attention matrix, and interact with classical components for tasks such as value vector multiplication and model distillation, as will be described in the detailed workflows of FIGS. 4-6.

In the transformer model, input x undergoes a series of linear transformations to produce the query (Q), key (K), and value (V) vectors. The input x, which is typically a word embedding or a sequence of embeddings, is multiplied by three distinct weight matrices Wq, Wk, and Wv to generate Q, K, and V, respectively. These matrices are learned parameters that help the model focus on different aspects of the input. The query vector Q represents the current word or token's role in the context, the key vector K encodes the relevance of other words or tokens, and the value vector V contains the actual information to be aggregated.

As mentioned previously, traditionally the self-attention mechanism computes attention scores by taking the dot product of Q and K, followed by a softmax operation to normalize these scores into probabilities. These probabilities are then used to weight the value vectors V, effectively determining how much attention each word or token should receive. The weighted sum of these value vectors produces the output x′, which is a contextually enriched representation of the input, capturing dependencies and relationships across the sequence. This output is then passed through further layers in the transformer to enhance the model's understanding and generate meaningful predictions.

The conceptualization of the self-attention matrix as a kernel gram matrix opens up innovative possibilities for utilizing quantum methods to both compute and learn the self-attention matrix kernel. By employing a parameterized quantum circuit (PQC), feature mapping can be implemented using QPU 310c, which can speed up the training process significantly compared to classical transformers executed on a CPU. This approach involves loading input x into a PQC using a unitary operation U_{φ}, which performs the feature mapping φ(x).

This process begins with encoding the Q into the quantum circuit. The unitary operation transforms the input data into a quantum state that represents the feature space. This transformation allows the quantum circuit to process the data in a high-dimensional space, capturing complex relationships and dependencies. The PQC is parameterized, meaning it includes adjustable parameters (e.g., ⊖₁, ⊖₂, etc.) that can be optimized to learn the desired kernel. By iteratively adjusting these parameters, the PQC can be trained to approximate the self-attention matrix kernel effectively. This quantum approach leverages the inherent parallelism and computational power of quantum circuits, potentially offering advantages over classical methods in terms of efficiency and capability.

Consider the following example.

Suppose that the input for quantum kernel 401 is (Qi, Kj), where Qi and Kj are scalars (this example can be trivially extended to vectors).

Suppose that the feature mapping function φ(x) has the following form:

$$ϕ ( x ) = ( \begin{matrix}cos ( {θ}_{1} x ) \\ sin ( {θ}_{1} x )\end{matrix} )$$

Let φ₁=π/4 (45 degrees)

The feature mapping becomes:

$$ϕ ( x ) = ( \begin{matrix}cos ( \frac{π}{4} x ) \\ sin ( \frac{π}{4} x )\end{matrix} )$$

The unitary operator U_{φ} is then applied using rotation gates on a single-qubit system where the initial state is: |0>

When applying parameterized rotation gates,

$${R}_{y} ( \frac{π}{4} \times {Q}_{i} )$$

is applied on the qubit:

$${R}_{y} ( \frac{π}{4} {Q}_{i} ) = ( \begin{matrix}cos ( \frac{π}{4} {Q}_{i} ) & - sin ( \frac{π}{4} {Q}_{i} ) \\ sin ( \frac{π}{4} {Q}_{i} ) & cos ( \frac{π}{4} {Q}_{i} )\end{matrix} )$$

Furthermore,

$${R}_{y} ( - \frac{π}{4} \times {K}_{j} )$$

is applied on the qubit:

$${R}_{y} ( - \frac{π}{4} {K}_{j} ) = ( \begin{matrix}cos ( \frac{π}{4} {K}_{j} ) & sin ( \frac{π}{4} {K}_{j} ) \\ - sin ( \frac{π}{4} {K}_{j} ) & cos ( \frac{π}{4} {K}_{j} )\end{matrix} )$$

The quantum circuit can be represented as follows:

$$\vert 0 〉 - {R}_{y} ( \frac{π}{4} {Q}_{i} ) - {R}_{y} ( - \frac{π}{4} {K}_{j} ) - 〈 0 \vert$$

After applying the unitary U_{φ}:

$$\vert ψ 〉 = {U}_{φ} \vert 0 〉 ,$$

the resulting quantum state represents the overlap between the feature-mapped representations of Qᵢ and Kⱼ. The measured probability for the all |0> state for this overlap provides the value for Aᵢⱼ, the i,j-th element of A. As a concrete example, suppose Qᵢ=3 and Kⱼ=4, then Aᵢⱼ=k(Qᵢ,Kⱼ)=cos²(π/4)=½. To extend this to the case where Qᵢ and Kⱼ are vectors, multiple qubits and vector data encodings may be used. This allows the use of a more expressive ansatz that incorporates 2-qubit entangling gates.

The matrix product of V and A ultimately yields x′. During the training phase, a target A value may be compared against the output A shown in FIG. 4. The loss between the two values may be used to update the parameters of the PQC, namely, ⊖₁ and ⊖₂ described in the example above. The parameters of the PQC may be stored in memory 320.

In some aspects, low-rank and/or sparse self-attention techniques are integrated into head 400, which may minimize the total number of kernel evaluations. This reduction in evaluations decreases the number of shots required on the quantum device to compute the self-attention matrix, thereby enhancing efficiency.

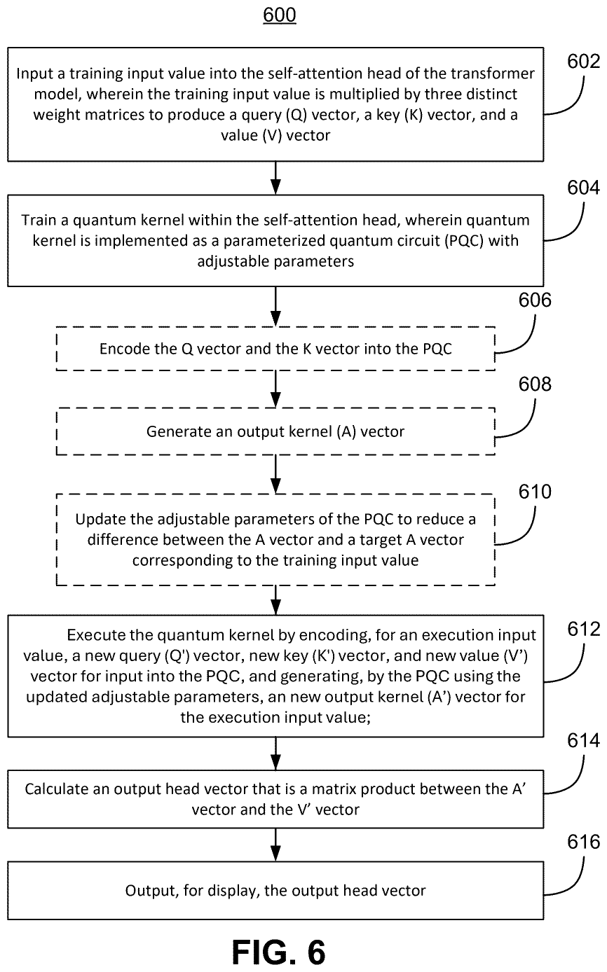

The parameterized quantum circuit (PQC) within quantum kernel 401 leverages quantum feature mapping to encode the query (Q) and key (K) vectors into high-dimensional quantum states using unitary operations, such as rotation gates. This process, as described in FIG. 4, allows the quantum circuit to represent complex relationships and dependencies in the input data that may be intractable for classical systems. By adjusting the gate angles (e.g., ⊖1, ⊖2), the PQC can learn a dynamic kernel tailored to the specific data, rather than relying on a fixed softmax dot-product kernel. This quantum approach exploits the inherent parallelism and computational power of quantum processors (e.g., QPU 310c), potentially reducing the time and resources required for training and inference in transformer models, as will be illustrated in the method steps of FIG. 6.

More specifically, this involves sparsely sampling the entries of the self-attention matrix. By selectively computing only a subset of the matrix entries and approximating the rest as zeros, the number of operations required is significantly reduced (this is merely a general example—low-rank methods don not explicitly treat the entries as zero, but assume the matrix can be approximated by compact factors, which is still ultimately formed by sub-sampling the matrix). This approach not only speeds up the computation of the self-attention matrix, but also simplifies the subsequent matrix multiplication, as operations involving zero entries can be skipped. This method effectively balances computational efficiency with model performance, making it a valuable strategy in the deployment of large-scale language models.

Conventional quantum transformers implement a fixed dot product kernel. However, the approach in the present disclosure allows for the use of a classically intractable ansatz as a feature mapping. This enables the learning of a classically intractable quantum kernel for self-attention, analogous to classical methods but with the added advantage of quantum computational power.

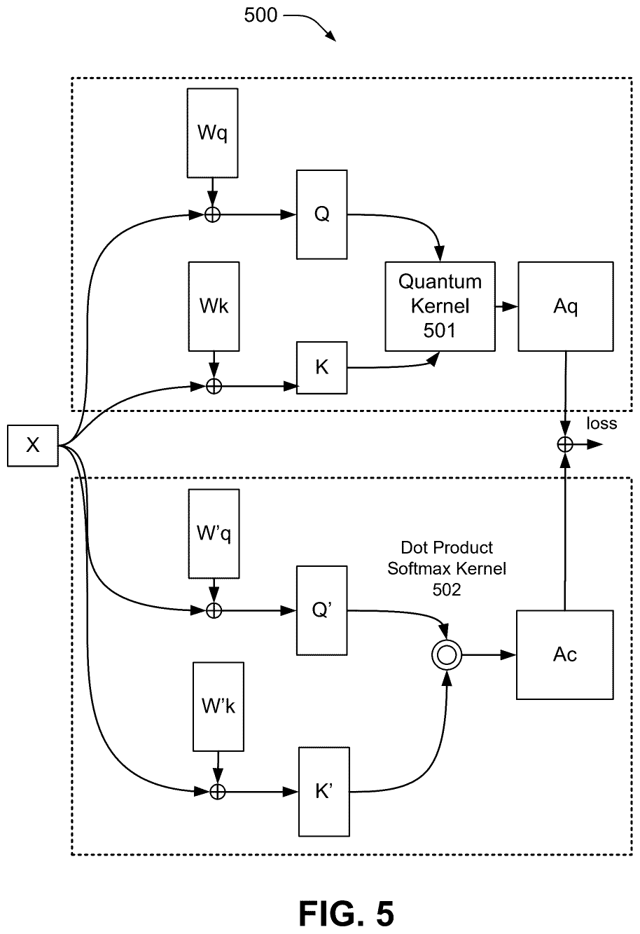

Furthermore, it is possible to learn the attention values for a pre-trained classical transformer, as depicted in FIG. 5. This capability allows for the potential compression or distillation of classical attention mechanisms for inference, optimizing the model's performance and resource usage. In FIG. 5, quantum kernel 501 is the learned version of quantum kernel 401. Leveraging this quantum kernel, W′q and W′k can be updated in a classical transformer head that has dot product softmax kernel 502. For a given input x, quantum kernel 501 yields Aq and dot product softmax kernel 502 yields Ac. The difference between Aq and Ac is the loss, which may be minimized using an optimization algorithm that updates W′q and W′k to improve the accuracy of Ac. In particular, the gap between Aq and Ac is measured using a simple loss on their attention matrices. After applying the same mask and normalizing rows with softmax, the average KL divergence between corresponding rows of Aq and Ac is computed. In setups that compare raw (unnormalized) matrices, the mean squared difference between Aq and Ac (their Frobenius norm) is used instead, optionally scaled by the number of valid entries.

Once the quantum kernel 501 has been trained to generate accurate self-attention matrices (Aq) using quantum feature mapping, kernel 501 may serve as a reference for classical transformer models that use the conventional dot product softmax kernel 502. As illustrated in FIG. 5, the classical model can be trained by minimizing the loss between its own attention output (Ac) and the quantum-derived attention output (Aq). This process involves updating the classical weight matrices (W′q and W′k) to better approximate the quantum attention mechanism. By distilling the quantum kernel's learned representations into the classical model, it is possible to compress or optimize the classical transformer's inference capabilities, potentially achieving improved accuracy or efficiency without requiring quantum hardware for deployment.

FIG. 6 illustrates an exemplary method 600 for executing a self-attention head with a quantum kernel in accordance with aspects of this disclosure.

A self-attention head is a transformer module that projects inputs into query (Q), key (K), and value (V) vectors, computes attention weights from Q·K (typically using scaled dot-product and softmax), and returns a context vector as a weighted sum of V. Multiple heads operate in parallel to capture different relational patterns, with each head learning its own projections and producing an output that is later concatenated and mixed.

At 602, processor 310 inputs a training input value into the self-attention head of the transformer model. This training input value is multiplied by three distinct weight matrices to produce a query (Q) vector, a key (K) vector, and a value (V) vector.

At 604, processor 310 begins training a quantum kernel (e.g., kernel 401) within the self-attention head (e.g., head 400). The quantum kernel is implemented as a parameterized quantum circuit (PQC) with adjustable parameters (e.g., gate angles such as ⊖₁ and ⊖₂). In some aspects, the transformer model comprises a plurality of self-attention heads each with a different quantum kernel. Each of the quantum kernels may be learned using the PQC-approach described in the present disclosure.

Training comprises steps 606, 608, and 610. For example, at 606, processor 310 encodes the Q vector and the K vector into the PQC. In some aspects, encoding the Q vector and the K vector comprises transforming the Q vector and the K vector into quantum states by performing feature mapping using a unitary operation. In some aspects, the unitary operation is applied using rotation gates on a two-qubit system. In some aspects, the first qubit is associated with the Q vector and the second qubit is associated with the K vector.

At 608, the quantum kernel generates an output kernel (A) vector. In some aspects, the measured probability for the all |0> states from the expanded quantum kernel (connected to quantum kernel 401 with a dotted line in FIG. 4) provides the value for an element of A.

At 610, processor 310 updates, using an optimization algorithm from algorithms component 210, the adjustable parameters of the PQC to reduce a difference between the A vector and a target A vector provided with the training input value.

At 612, processor 310 executes the trained quantum kernel. This involves encoding, for an execution input value, a new query (Q′) vector, new key (K′) vector, and new value (V′) vector for input into the PQC, and subsequently generating, by the PQC using the updated adjustable parameters, an new output kernel (A′) vector for the execution input value.

At 614, processor 310 calculates an output head vector that is a matrix product between the A vector and the V vector. The output head vector is the per-head context representation produced by multiplying the attention matrix A with the value matrix V (i.e., A·V), yielding a length-d head vector for each token that captures information aggregated by that head.

At 616, processor 310 outputs, for display (e.g., user interface 350), the output head vector. In some aspects, the output head vector may be output for display as a numeric vector or table for selected token(s), and may be visualized as a bar plot or shown alongside the attention heatmap for interpretability; in multi-head settings, individual head vectors are later concatenated and mixed downstream.

In practice, method 600 is implemented using the self-attention head and quantum kernel modules shown in FIGS. 4-5. Processor 310—using QPU 310c during quantum kernel training and CPU/GPU 310a/310b during classical distillation—executes algorithms component 210 to encode Q and K, generate Aq via the PQC (401/501), and store learned parameters in memory 320. The same head computes Ac with the dot-product softmax kernel 502, and the loss between Aq and Ac updates W′q and W′k. This end-to-end flow leverages the existing data paths of FIGS. 4-5, enabling training and deployment without hardware beyond the illustrated components.

In some aspects, processor 310 integrates, using algorithms component 210, sparse self-attention in the self-attention head by selectively computing only a subset of matrix entries and approximating all remainder entries as zero.

In some aspects, after the quantum kernel (e.g., kernel 501) has been learned, processor 310 (specifically CPU 310a or GPU 310b rather than QPU 310c as used in the steps of method 600) may train a classical transformer model executing a dot product softmax kernel (e.g., kernel 502) using the A vector generated by the quantum kernel (e.g., Aq) as a true A vector for a given input value. This may involve a loss between the Aq vector and a classical Ac vector generated by the dot product softmax kernel being used to update weight matrices (e.g., W′q and W′k) of the classical transformer model.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method for executing a quantum kernel in a self-attention head of a transformer model, the method comprising:
inputting a training input value into the self-attention head of the transformer model, wherein the training input value is multiplied by three distinct weight matrices to produce a query (Q) vector, a key (K) vector, and a value (V) vector,
training a quantum kernel within the self-attention head, wherein quantum kernel is implemented as a parameterized quantum circuit (PQC) with adjustable parameters, and wherein the training comprises:
encoding the Q vector and the K vector for input into the PQC;
generating an output kernel (A) vector; and
updating the adjustable parameters of the PQC to reduce a difference between the A vector and a target A vector corresponding to the training input value;
executing the quantum kernel by:
encoding, for an execution input value, a new query (Q′) vector, new key (K′) vector, and new value (V′) vector for input into the PQC, and
generating, by the PQC using the updated adjustable parameters, an new output kernel (A′) vector for the execution input value;
calculating an output head vector that is a matrix product between the A′ vector and the V′ vector; and
outputting, for display, the output head vector.

2. The method of claim 1, wherein encoding the Q vector and the K vector comprises transforming the Q vector and the K vector into quantum states by performing feature mapping using a unitary operation.

3. The method of claim 2, wherein the unitary operation is applied using rotation gates in a two-qubit system.

4. The method of claim 3, wherein a first qubit is associated with the Q vector and a second qubit is associated with the K vector.

5. The method of claim 1, further comprising integrating sparse self-attention in the self-attention head by selectively computing only a subset of matrix entries and approximating all remainder entries as zero.

6. The method of claim 1, further comprising:
training a classical transformer model executing a dot product softmax kernel using the A vector generated by the quantum kernel as a true A vector for a given input value.

7. The method of claim 6, wherein a loss between the A vector and a classical A vector generated by the dot product softmax kernel is used to update weight matrices of the classical transformer model.

8. The method of claim 1, where the adjustable parameters are gate angles.

9. The method of claim 1, wherein the transformer model comprises a plurality of self-attention heads each with a different quantum kernel.

10. A quantum information processing (QIP) system for executing a quantum kernel in a self-attention head of a transformer model, the QIP system comprising:
at least one memory; and
at least one processor coupled with the at least one memory and configured, individually or in combination, to:
input a training input value into the self-attention head of the transformer model, wherein the training input value is multiplied by three distinct weight matrices to produce a query (Q) vector, a key (K) vector, and a value (V) vector,
train a quantum kernel within the self-attention head, wherein quantum kernel is implemented as a parameterized quantum circuit (PQC) with adjustable parameters, and wherein training comprises:
encoding the Q vector and the K vector for input into the PQC;
generating an output kernel (A) vector; and
updating the adjustable parameters of the PQC to reduce a difference between the A vector and a target A vector corresponding to the training input value;
execute the quantum kernel by:
encoding, for an execution input value, a new query (Q′) vector, new key (K′) vector, and new value (V′) vector for input into the PQC, and
generating, by the PQC using the updated adjustable parameters, an new output kernel (A′) vector for the execution input value;
calculate an output head vector that is a matrix product between the A′ vector and the V′ vector; and
output, for display, the output head vector.

11. The QIP system of claim 10, wherein encoding the Q vector and the K vector comprises transforming the Q vector and the K vector into quantum states by performing feature mapping using a unitary operation.

12. The QIP system of claim 11, wherein the unitary operation is applied using rotation gates in a two-qubit system.

13. The QIP system of claim 12, wherein a first qubit is associated with the Q vector and a second qubit is associated with the K vector.

14. The QIP system of claim 10, further comprising integrating sparse self-attention in the self-attention head by selectively computing only a subset of matrix entries and approximating all remainder entries as zero.

15. The QIP system of claim 10, further comprising:
training a classical transformer model executing a dot product softmax kernel using the A vector generated by the quantum kernel as a true A vector for a given input value.

16. The QIP system of claim 15, wherein a loss between the A vector and a classical A vector generated by the dot product softmax kernel is used to update weight matrices of the classical transformer model.

17. The QIP system of claim 10, where the adjustable parameters are gate angles.

18. The QIP system of claim 10, wherein the transformer model comprises a plurality of self-attention heads each with a different quantum kernel.
